(19) United States
(12) Patent Application Publication
(10) Pub. No.: US 2015/0064570 A1
(43) Pub. Date: Mar. 5, 2015

(54) THIN AND FLEXIBLE ELECTROCHEMICAL CELLS

(71) Applicants: VARTA Microbattery GmbH, Ellwangen Jagst (DE); SAATI S.p.A., Legnano (IT)

(72) Inventors: Michael Wendler, Neuhausen (DE); Carmine Lucignano, Tradate (VA) (IT)

(21) Appl. No.: 14/475,669

(22) Filed: Sep. 3, 2014

(30) Foreign Application Priority Data
Sep. 4, 2013 (EP) 13183044.0

(51) Int. Cl. H01M 4/66; H01M 4/74

(52) U.S. Cl. CPC H01M 4/668; H01M 4/74
USPC 429/241

(57) ABSTRACT

An electrochemical cell has at least one positive electrode, at least one negative electrode and at least one separator arranged between the electrodes. At least one of the electrodes includes a first, coarser mesh and a second, finer mesh. The first and the second mesh at least differ in that the first mesh consists of threads having a larger diameter than the threads of which the second mesh consists, and/or in that the first mesh has mesh openings having a larger opening width than the openings of the second mesh. However, both are woven meshes made of monofilaments. The threads of the first and/or the second mesh are coated with an electrically conducting material and serve as current collectors of the at least one electrode.

### TECHNICAL FIELD

This disclosure relates to thin and flexible electrochemical cells, in particular cells produced by printing or slot-die-coating technology.

### BACKGROUND

The term “battery” originally meant a plurality of electrochemical cells connected in series. However, single electrochemical cells are nowadays frequently also referred to as batteries. During the discharge of a battery, an energy-supplying chemical reaction made up to two electrically coupled but physically separate subreactions takes place. One subreaction taking place at a comparatively low redox potential proceeds at the negative electrode, while a subreaction at a comparatively higher redox potential proceeds at the positive electrode. During discharge, electrons are liberated at the negative electrode by an oxidation process, resulting in flow of electrons via an external load to the positive electrode which takes up a corresponding quantity of electrons. A reduction process thus takes place at the positive electrode. At the same time, an ion current corresponding to the electrode reaction occurs within the cell. This ion current is achieved by an ionically conductive electrolyte. In secondary cells and batteries, this discharge reaction is reversible, and it is thus possible to reverse the transformation of chemical energy into electric energy which occurs during discharge. If the terms anode and cathode are used in this context, the electrodes are generally named according to their discharge function. In such cells, the negative electrode is thus the anode, and the positive electrode is the cathode.

For an increasing number of applications thin batteries are needed which are more flexible and light-weight than conventional batteries. Very thin batteries are often produced by printing technologies. However, printed electrodes are often brittle and tend to break under mechanical stress and motions.

There is thus a need for a new types of thin batteries having a more flexible design and being more resistant against mechanical impacts, bending and folding.

### SUMMARY

We provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the threads of the first and/or the second mesh consist of a plastic selected from a group consisting of polyamide plastic, polyester plastic, polyolefin plastic and polyether ether ketone plastic.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the electrically conducting material is a metallic material selected from a group consisting of nickel, copper, aluminium, iron and alloys thereof.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the diameter of the threads of the first mesh exceeds the diameter of the threads of the second mesh by a factor of at least about 1.5.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the threads of the first mesh have a diameter of about 40 μm to about 500 μm.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the threads of the second mesh have a diameter of about 15 μm to about 300 μm.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the opening width of the mesh openings of the first mesh exceeds the opening width of the mesh openings of the second mesh by a factor of at least about 1.1.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the at least one electrode including the first and the second mesh and the separator are configured as layers.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, wherein the at least one electrode including the first and the second mesh and the separator are configured as layers and wherein the thickness of the layers is about 150 μm to about 1000 μm.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, wherein the at least one electrode including the first and the second mesh and the separator are configured as layers and wherein one of the sides of the electrode is in 2-dimensional contact with the separator.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, wherein the at least one electrode including the first and the second mesh and the separator are configured as layers and wherein the first and the second mesh are arranged in a stack-like arrangement atop each other and the first mesh is in 2-dimensional contact with the second mesh.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, wherein the at least one electrode including the first and the second mesh and the separator are configured as layers and wherein the first mesh faces towards the separator layer.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the diameter of the threads of the first mesh exceeds the diameter of the threads of the second mesh by a factor of at least about 2 to about 50.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the threads of the first mesh have a diameter of about 61 μm to about 260 μm.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the threads of the second mesh have a diameter of about 27 μm to about 145 μm.

We also provide an electrochemical cell including at least one positive electrode, at least one negative electrode and at least one separator arranged between the electrodes, wherein at least one of the electrodes includes a layer of a first, coarser mesh and a second, finer mesh, wherein the first and the second mesh are monofilament woven meshes, and the first mesh consists of threads having a larger diameter than the threads of which the second mesh consists, and/or wherein the first mesh has mesh openings having a larger opening width than the openings of the second mesh, and the threads of the first and/or the second mesh are coated with an electrically conducting material and serve as current collectors of the at least one electrode, and wherein the opening width of the mesh openings of the first mesh exceeds the opening width of the mesh openings of the second mesh by a factor of at least about 1.5 to about 100.

### BRIEF DESCRIPTION OF THE DRAWINGS

FIG. 1 schematically illustrates a cross section through a preferred example of a textile fabric which is suitable as current collector of an electrochemical cell.

FIG. 2 schematically illustrates a cross section through an alternative preferred example of a textile fabric which is suitable as current collector of an electrochemical cell.

FIG. 3 shows the textile fabric of FIG. 2, wherein the mesh openings of mesh (A) are filled with an electrochemically active material (D).

FIG. 4 schematically illustrates a cross section through a preferred example of an electrochemical cell.

### DETAILED DESCRIPTION

It will be appreciated that the following description is intended to refer to specific examples of structure selected for illustration in the drawings and is not intended to define or limit the disclosure, other than in the appended claims.

Like conventional cells, our electrochemical cells have at least one positive electrode, at least one negative electrode and at least one separator arranged between the electrodes. At least one of the electrodes, preferably all electrodes of the cell, comprises a current collector.

In contrast to conventional cells, at least one of the electrodes of the cell comprises a first, coarser mesh and a second, finer mesh. The first and the second mesh at least differ in at least one of the following features:
Thread Diameter: Preferably, the first mesh consists of threads having a larger diameter than the threads of which the second mesh consists.
Mesh openings: Preferably, the first mesh has mesh openings having a larger opening width than the openings of the second mesh.

For example, the first mesh may have 26 threads per cm, a thread diameter of 120 micrometers (μm) with a mesh opening of 265 μm and a thickness of 223 μm, wherein the second mesh may have 43 threads per cm, a thread diameter of 61 μm with a mesh opening of 170 μm and a total thickness of 105 μm.

Usually, the first mesh has both threads with a larger diameter as well as mesh openings having a larger opening width.

At least one of the meshes is coated with an electrically conducting material. The coated threads act as current collectors of the at least one electrode. In a first preferred example, the second mesh is coated with the electrically conducting material, wherein the first mesh is not coated. In a second preferred example, the first and the second mesh are both coated with the electrically conducting material. Preferably, the threads of the meshes are totally encapsulated by a continuous layer of the electrically conducting material.

If both meshes are coated with an electrically conducting material it is preferred that the coatings consist of the same electrically conducting material.

In it important that the first and the second mesh are both monofilament woven meshes. That means that each of the meshes is a woven mesh made of identical filaments having the same diameter and the same chemical nature.

It is preferred that the mesh openings of the first and/or the second mesh are filled with an electrochemically active material. In other words, it is preferred that the meshes are embedded in a matrix comprising the electrochemically active material and—if applicable—additional electrode components like a binder and/or a conductive agent.

Surprisingly, we found that by incorporating the first and the second mesh into the at least one electrode, flexibility and resistance of the electrode was significantly improved without having a negative impact on other properties of the electrode such as capacity or internal resistance. The first mesh has the capability of taking up large amounts of electrochemically active material, wherein the second mesh coated with the electrically conducting material is able to act as current collector having high conductivity.

The electrochemically active material filling the mesh openings is preferably selected from the group consisting of zinc, manganese dioxide, metal hydride and nickel hydroxide.

The filaments of the first and/or the second mesh preferably consist of a plastic, wherein the plastic is more preferably selected from a group consisting of polyamide plastic, polyester plastic, polyolefin plastics such as polypropylene and polyether ether ketone plastic. Particularly preferably, the first and the second mesh both consist of a polyamide plastic.

The electrically conducting material coating the meshes is preferably a metallic material, more preferably a metal selected from a group consisting of nickel, copper, aluminium and iron or an alloy of at least one of these metals, for example, stainless steel. Particularly preferred is a copper coating for zinc electrodes and a nickel coating for manganese dioxide, metal hydride or nickel hydroxide electrodes.

The coating may also comprise more than one layer of an electrically conducting material. For example, to increase the mesh conductivity a first layer of copper (for example, by magnetron sputtering) and a second layer of nickel (for example, by galvanic deposition) may be sequentially deposited on the threads of the meshes.

The coating may be applied on the threads of the meshes by processes such as sputtering, PVD, chemical reduction or electro-deposition.

The thickness of the coating is preferably about 10 nm to about 2 μm.

Preferably, the diameter of the threads of the first mesh exceeds the diameter of the threads of the second mesh by a factor of at least about 1.5, preferably by a factor of 2 to 50.

The threads of the first mesh preferably have a diameter of about 40 μm to about 500 μm, more preferably about 61 μm to about 260 μm (the diameter ranges are referring to the diameters of the bare threads without the coating).

Further, it is preferred that the threads of the second mesh have a diameter of about 15 μm to about 300 μm, preferably about 27 μm to about 145 μm (the diameter ranges are referring to the diameters of the bare threads without the coating).

The opening width of the mesh openings of the first mesh preferably exceeds the opening width of the mesh openings of the second mesh by a factor of at least about 1.1, preferably by a factor of about 1.5 to about 100.

Preferably, the at least one electrode comprising the first and the second mesh and/or the separator are configured as layers. Preferably, the electrode and the separator are configured as layer composite, wherein the electrode is in 2-dimensional contact with the separator. The electrode and the separator can be joined, for example, by a lamination process. The thicknesses of the electrode and separator layers are preferably about 150 μm to about 1000 μm.

In the at least one electrode, the first and the second mesh are preferably arranged in a stack-like arrangement atop each other. It is preferred that the first mesh is in 2-dimensional contact with the second mesh. It is even more preferred that the meshes are fixed to one another, for example, by adhesive bonding, by lamination, in particular by hot melt lamination, by sewing or by ultrasound sealing, thereby forming a textile fabric comprising two mesh-layers.

To obtain such a textile fabric, reactive polyurethane may be deposed between the first and the second mesh on several points or along a line, followed by a pressure treatment in a lamination device and curing of the reactive polyurethane, for example, in an oven.

The first, coarser mesh preferably faces towards the separator layer.

To obtain our electrochemical cells, a textile fabric consisting of the first and second mesh may be overprinted or coated with a paste or ink formulation containing one of the electrochemically active materials additional electrode components, for example, using screen-printing or slot-die-coating technology, thereby filling the mesh openings of the first and the second mesh. In a subsequent step an electrolyte/separator combination as described in DE 102010018071 may be applied via a screen-printing process or slot-die-coating on top of the obtained electrode. The obtained electrode-separator-composite may be combined with an appropriate counter electrode.

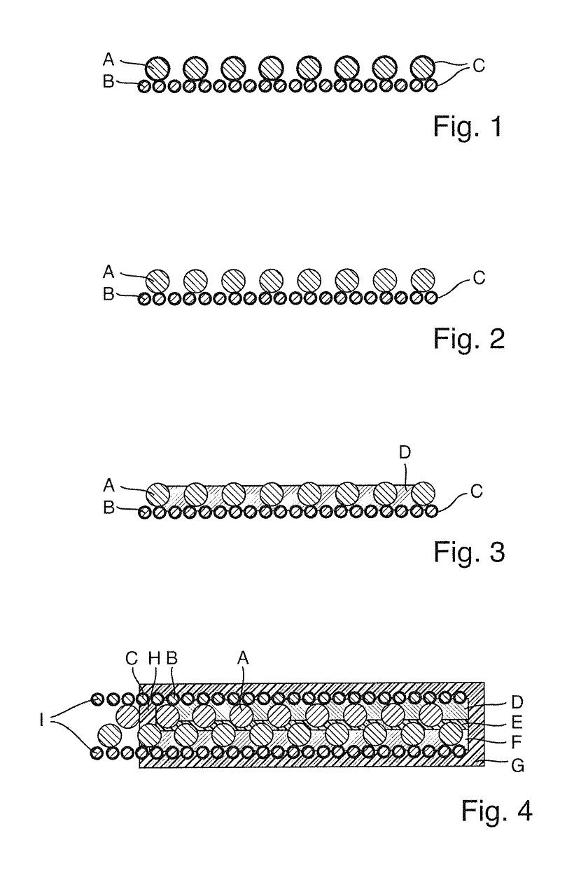

Turning now to the Drawings, FIG. 1 shows an electrochemical cell which comprises two mesh-layers. The first, coarser mesh (A) and/or the second, finer mesh (B), are both coated with an electrically conducting material, for example with nickel or copper. In a preferred embodiment both meshes, the finer and the coarser, are monofilament woven meshes and consist of a polyamide. The textile fabric is produced by combining the first and the second mesh in a lamination process. The coating is applied to the meshes preferably after lamination but in some cases also in advance.

FIG. 2 shows an electrochemical cell which comprises two mesh-layers. The first, coarser mesh (A) is not metallised. The second, finer mesh (B), is coated with an electrically conducting material, for example with nickel or copper. In a preferred embodiment both meshes, the finer and the coarser, are monofilament woven meshes and consist of a polyamide. The textile fabric is produced by combining the first and the second mesh in a lamination process. The coating is applied to the second mesh (B) preferably before lamination.

FIG. 3 shows the textile fabric of FIG. 2, wherein the mesh openings of mesh (A) are filled with an electrochemically active material (D). The electrochemically active material could be a paste or ink formulation which contains zinc, manganese dioxide, metal hydride, nickel hydroxide and so on.

In FIG. 4, a first and a second electrode of opposite polarity are connected via the separator layer (E). The separator layer is preferably produced via screen-printing or slot-die-coating. The first electrode comprises the electrochemically active material (D), the second electrode comprises the electrochemically active material (F). Both electrodes comprise the textile fabric of FIG. 2, wherein in both cases the fabric is arranged such that the coarser mesh (A) faces towards the separator layer (E). The electrochemically active materials (D) and (F) are printed or coated onto the textile fabrics, thereby filling the mesh openings at least of the coarser meshes.

The two electrodes and the separator are enclosed by the housing (G). The open end of the housing is sealed or encapsulated by the sealant (H) which is, for example, a polysiloxane compound. The two fabrics, in particular the meshes (C) coated with the electrically conducting material, are led through the sealant to the outer part of the cell, thereby providing contact areas (I).

Although our electrochemical cells have been described in connection with specific forms thereof, it will be appreciated that a wide variety of equivalents may be substituted for the specified elements described herein without departing from the spirit and scope of this disclosure as described in the appended claims.

1. An electrochemical cell comprising at least one positive electrode, at least one negative electrode and at least one separator arranged between the electrodes, wherein at least one of the electrodes comprises a layer of a first, coarser mesh and a second, finer mesh, wherein
the first and the second mesh are monofilament woven meshes, and
the first mesh consists of threads having a larger diameter than the threads of which the second mesh consists, and/or
wherein the first mesh has mesh openings having a larger opening width than the openings of the second mesh, and
the threads of the first and/or the second mesh are coated with an electrically conducting material and serve as current collectors of the at least one electrode.

2. The electrochemical cell according to claim 1, wherein the threads of the first and/or the second mesh consist of a plastic selected from a group consisting of polyamide plastic, polyester plastic, polyolefin plastic and polyether ether ketone plastic.

3. The electrochemical cell according to claim 1, wherein the electrically conducting material is a metallic material selected from a group consisting of nickel, copper, aluminium, iron and alloys thereof.

4. The electrochemical cell according to claim 1, wherein the diameter of the threads of the first mesh exceeds the diameter of the threads of the second mesh by a factor of at least about 1.5.

5. The electrochemical cell according to claim 1, wherein the threads of the first mesh have a diameter of about 40 μm to about 500 μm.

6. The electrochemical cell according to claim 1, wherein the threads of the second mesh have a diameter of about 15 μm to about 300 μm.

7. The electrochemical cell according to claim 1, wherein the opening width of the mesh openings of the first mesh exceeds the opening width of the mesh openings of the second mesh by a factor of at least about 1.1.

8. The electrochemical cell according to claim 1, wherein the at least one electrode comprising the first and the second mesh and the separator are configured as layers.

9. The electrochemical cell according to claim 8, wherein the thickness of the layers is about 150 μm to about 1000 μm.

10. The electrochemical cell according to claim 8, wherein one of the sides of the electrode is in 2-dimensional contact with the separator.

11. The electrochemical cell according to claim 8, wherein the first and the second mesh are arranged in a stack-like arrangement atop each other and the first mesh is in 2-dimensional contact with the second mesh.

12. The electrochemical cell according to claim 8, wherein the first mesh faces towards the separator layer.

13. The electrochemical cell according to claim 1, wherein the diameter of the threads of the first mesh exceeds the diameter of the threads of the second mesh by a factor of at least about 2 to about 50.

14. The electrochemical cell according to claim 1, wherein the threads of the first mesh have a diameter of about 61 μm to about 260 μm.

15. The electrochemical cell according to claim 1, wherein the threads of the second mesh have a diameter of about 27 μm to about 145 μm.

16. The electrochemical cell according to claim 1, wherein the opening width of the mesh openings of the first mesh exceeds the opening width of the mesh openings of the second mesh by a factor of at least about 1.5 to about 100.
